(19) United States
(12) Patent Application Publication
(10) Pub. No.: US 2012/0120553 A1
(43) Pub. Date: May 17, 2012

(54) SOLID ELECTROLYTIC CAPACITOR AND METHOD FOR MANUFACTURING THE SAME

(75) Inventors: Sung Wook HAN, Seoul (KR); Kwan Hyeong Kim, Suwon (KR); Jeong Oh Hong, Seoul (KR)

(73) Assignee: SAMSUNG ELECTRO-MECHANICS CO., LTD.

(21) Appl. No.: 13/025,794

(22) Filed: Feb. 11, 2011

(30) Foreign Application Priority Data
Nov. 12, 2010 (KR) 10-2010-0112459

(51) Int. Cl. H01G 9/15; H01G 9/00

(52) U.S. Cl. 361/523; 29/25.03

(57) ABSTRACT

There is provided a solid electrolytic capacitor, including: a condenser element including a positive electrode wire inserted and mounted to be biased from a center of a chip body; a positive electrode terminal including a pattern layer extendedly formed to the positive electrode wire to be bonded to the positive electrode wire; and a negative electrode terminal electrically connected to the condenser element.

### CROSS-REFERENCE TO RELATED APPLICATIONS

This application claims the priority of Korean Patent Application No. 10-2010-0112459 filed on Nov. 12, 2010, in the Korean Intellectual Property Office, the disclosure of which is incorporated herein by reference.

### BACKGROUND OF THE INVENTION

1. Field of the Invention

The present invention relates to a solid electrolytic capacitor and a method for manufacturing the same, and more particularly, to a solid electrolytic capacitor including a positive electrode wire and a method for manufacturing the same.

2. Description of the Related Art

A mold package of an existing surface mounting part type is configured as a type in which an electrode is extracted from a side surface of a product to an outside or a bottom surface thereof.

A solid electrolytic capacitor of a surface-mounting chip type is manufactured by extracting an external electrode at about half of a side height of the package in the case of the side electrode and bending the extracted external electrode to have a predetermined shape.

In order to increase a volumetric ratio of devices in the package, a lead frame for external extraction, that is, a structure for a bottom electrode for disposing the external electrode at the bottom surface of the product is adopted.

However, in the case of the side electrode, since the external electrode is extracted at about half of a package side height and a bonding height of the external electrode to a positive electrode wire included in the condenser element is varied according to the height of the condenser element, it is necessary to perform a preparing process for bonding the positive electrode wire to the external electrode.

That is, the external electrode and the positive electrode wire are bonded to each other in order to correspond to the change in bonding height by bending the external electrode or mounting a spacer, or the like, in the external electrode. Therefore, there is a problem in that the number of processes in manufacturing a solid electrolytic capacitor is increased.

### SUMMARY OF THE INVENTION

An aspect of the present invention provides an easily manufactured solid electrolytic capacitor.

Another aspect of the present invention provides a method for manufacturing a solid electrolytic capacitor capable of reducing the number of manufacturing processes in order to improve manufacturing efficiency.

According to an aspect of the present invention, there is provided a solid electrolytic capacitor, including: a condenser element including a positive electrode wire inserted and mounted to be biased from a center of a chip body; a positive electrode terminal including a pattern layer extendedly formed to the positive electrode wire to be bonded to the positive electrode wire; and a negative electrode terminal electrically connected to the condenser element.

The solid electrolytic capacitor may further include a molding part surrounding the condenser element mounted with the positive electrode wire to protrude the positive electrode terminal and the negative electrode terminal to the outside.

The solid electrolytic capacitor may further include a negative electrode extracting layer stacked on an outer surface of the condenser element and contacting the negative electrode terminal.

The positive electrode terminal and the negative electrode terminal may be bent along the outer surface of the molding part to be extended to the bottom surface of the molding part.

According to another aspect of the present invention, there is provided a method for manufacturing a solid electrolytic capacitor, including: molding a condenser element so that a positive electrode wire is disposed to be biased; mounting the condenser element on the positive electrode terminal and the negative electrode terminal so that an end portion of the positive electrode wire is seated on the pattern layer of the positive electrode terminal; and forming a molding part to surround the condenser element and the positive electrode wire.

The method for manufacturing a solid electrolytic capacitor may further include, prior to the molding of the condenser element, forming a pattern layer bonded to the positive electrode wire mounted to be biased to the condenser element at one end portion of the positive electrode terminal.

The positive electrode wire maybe mounted to be biased to the pattern layer of the positive electrode terminal.

The method for manufacturing a solid electrolytic capacitor may further include, after the forming of the molding part, bending the positive electrode terminal and the negative electrode terminal to be extended to the bottom surface of the molding part along the outer surface of the molding part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a solid electrolytic capacitor according to an exemplary embodiment of the present invention;

FIG. 2 is an enlarged view showing part A of FIG. 1; and

FIGS. 3 to 8 are process flow diagrams for explaining a method for manufacturing a solid electrolytic capacitor according to an exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, and those are to be construed as being included in the spirit of the present invention.

Further, when it is determined that the detailed description of the known art related to the present invention may obscure the gist of the present invention, the detailed description thereof will be omitted.

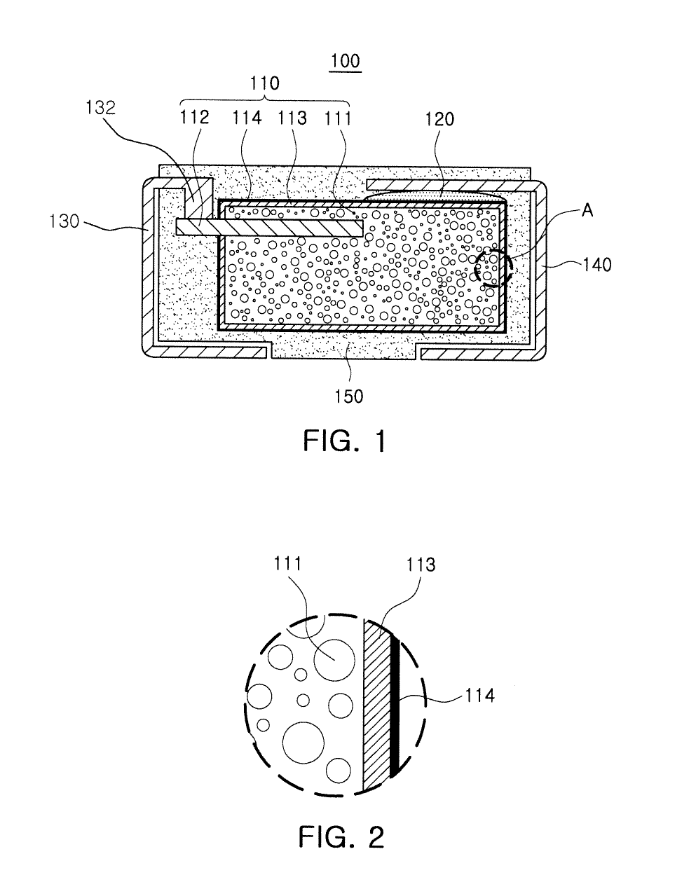

FIG. 1 is a schematic cross-sectional view showing a solid electrolytic capacitor according to an exemplary embodiment of the present invention and FIG. 2 is an enlarged view showing part A of FIG. 1.

Referring to FIGS. 1 and 2, a solid electrolytic capacitor 100 according to an exemplary embodiment of the present invention may be configured to include a condenser element 110, a negative electrode extracting layer 120, a positive electrode terminal 130, a negative electrode terminal 140, and a molding part 150.

The condenser element 110 includes a positive electrode wire 112 inserted and mounted to be biased from a center of the chip body. Described in more detail, the condenser element 110 may configured to include a chip body 111, a positive electrode wire 112, a carbon layer 113, and a silver paste layer 114.

The chip body 111 may be molded by sintering and may be molded using a material such as tantalum, niobium (NB) oxide, or the like. Meanwhile, the case in which the chip body 111 is manufactured by using the tantalum material will be described by way of example. The chip body 111 is molded by mixing a tantalum powder with a binder at a predetermined ratio and agitating it, compressing the mixed powder to mold it into a rectangular parallelepiped shape, and then, sintering it under conditions of high temperature and high vibrations.

Meanwhile, the positive electrode wire 112 is inserted and mounted to be biased from the center the chip body before compressing the mixed powder.

In addition, the chip body 111 may be formed with an insulating layer (not shown) and a negative electrode layer (not shown), wherein the insulating layer maybe formed at the outer surface of the chip body 111 and the negative electrode layer may be formed on the insulating layer.

That is, the insulating layer may be formed by growing an oxide layer Ta₂O₅ on the surface of the chip body 111 by a formation process using electrochemical reaction. In this case, the insulating layer changes the chip body 111 into a dielectric.

The negative electrode layer is stacked on the insulating layer and may be made of manganese dioxide (MnO₂) or a conductive polymer. In the case of manganese dioxide, the negative electrode layer may be formed by impregnating the chip body 111 formed with the insulating layer in the manganese nitrate solution and then, being subjected to the pyrolysis process and in the case of the conductive polymer, the negative electrode layer having a conductive polymer negative electrode may be formed at the outer surface of the chip body 111 formed with the insulating layer by using a chemical polymerization method or an electrolysis polymerization method using 3,4-ethylenedioxythiophene (EDOT) or a pyrrole monomer.

Meanwhile, the carbon layer 113 may be stacked on the negative electrode layer and the silver paste layer 114 may be stacked on the carbon layer 113 in order to improve conductivity. That is, the carbon layer 113 and the silver paste layer 114 may be stacked by being sequentially applied to the negative electrode layer. In addition, the carbon layer 113 and the silver paste layer 114 facilitate the electrical connection for polarity transfer by improving the conductivity for polarity of the negative electrode layer.

The negative electrode extracting layer 120 is stacked on the external surface of the condenser element 110 to contact the negative electrode terminal 140. That is, the negative electrode extracting layer 120 is stacked to be electrically connected to the negative electrode layer and is stably bonded to the negative electrode terminal 140 to extract the negative electrode terminal.

In addition, the negative electrode extracting layer 120 may be made of a conductive paste made of gold (Au), lead (Pb), silver (Ag), nickel (Ni), copper (Cu), or the like, having viscosity, and which is applied to one surface of the condenser element 110 in order to have sufficient strength and hardness from the drying, hardening, and sintering processes.

Meanwhile, the negative electrode extracting layer 120 may be hardened at a temperature of between approximately 20 and 300° C.

In addition, the negative electrode extracting layer 120 may be formed on one surface of the condenser element 110 by a dispensing method, a dipping method to attach a predetermined amount of paste to one surface thereof, or a printing method to print paste onto a sheet and attach it to one surface of the condenser element 110, or the like.

The positive electrode terminal 130 includes the pattern layer 132 is extendedly formed to the positive electrode wire 112 in order to be bonded to the positive electrode wire 112.

Further, the pattern layer 132 is integrally formed with the positive electrode terminal 130 according to the height of the positive electrode wire 112 of the condenser element 110 and when the condenser element 110 is seated on the positive electrode terminal 130, the pattern layer 132 contacts the positive electrode wire 112 of the condenser element 110.

That is, the pattern layer 132 is integrally formed with the positive electrode terminal 130 and the positive electrode wire 112 is seated on the pattern layer 132 to be electrically connected to the positive electrode terminal 130 by only seating the condenser element 110 on the positive electrode terminal 130.

Further, although the mounting height of the positive electrode wire 112 is varied according to the size change of the condenser element 110, the height of the pattern layer 132 is changed, such that the positive electrode wire 112 may be electrically connected to the positive electrode terminal 130 by seating the condenser element 110 on the positive electrode terminal 130.

Thereafter, the positive electrode wire 112 and the pattern layer 132 may be bonded to each other by welding. Therefore, the positive electrode wire 112 and the pattern layer 132 may be firmly bonded to each other.

The negative electrode terminal 140 is electrically connected to the condenser element 110. That is, the negative electrode terminal 140 contacts the negative electrode extracting layer 120 to be electrically connected to the condenser element 110.

Meanwhile, the positive electrode terminal 130 and the negative electrode terminal 140 are bent along the outer surface of the molding part 150 to be extended to the bottoms surface of the molding part 150. That is, the positive electrode terminal 130 and the negative electrode terminal 140 are bent to correspond to the shape of the condenser element 110, thereby making it possible to improve volumetric efficiency.

The molding part 150 is formed to surround the condenser element 110 while protruding the positive electrode terminal 130 and the negative electrode terminal 140 to the outside. The molding part 150 is formed to surround the condenser element 110 in order to protect the condenser element 110 from the external environment.

The molding part 150 may be made of an epoxy material and the molding part 150 may be made of an epoxy material including a filler having a relatively large size.

As described above, the positive negative terminal 130 and the positive electrode wire 112 are easily bonded to each other without needing to mount an auxiliary combining member such as a spacer, or the like, for bonding the positive electrode wire 112 to the positive electrode terminal 130 through the positive electrode terminal 130 integrally formed with the pattern layer 132 or without bending the positive electrode terminal 130.

That is, the positive electrode wire 112 contacts the pattern layer 132 of the positive electrode terminal 130 by only seating the condenser element 110 mounted to lean the positive electrode wire 112 on the positive electrode terminal 130, such that the additional process for bonding the positive electrode wire 112 to the positive electrode terminal 130 maybe omitted.

Consequently, the number of manufacturing processes can be reduced and manufacturing efficiency can be improved accordingly.

In addition, even when solid electrolysis capacitors 100, having various sizes, are manufactured, the height of the pattern layer 132 maybe changed according to the biased degree of the positive electrode wire 112, such that the solid electrolytic capacitor 100 having various sizes may be more easily manufactured.

Hereinafter, the solid electrolytic capacitor according to the exemplary embodiment of the present invention will be described with reference to the drawings. Meanwhile, the same components as the foregoing components will be described using reference numerals already used.

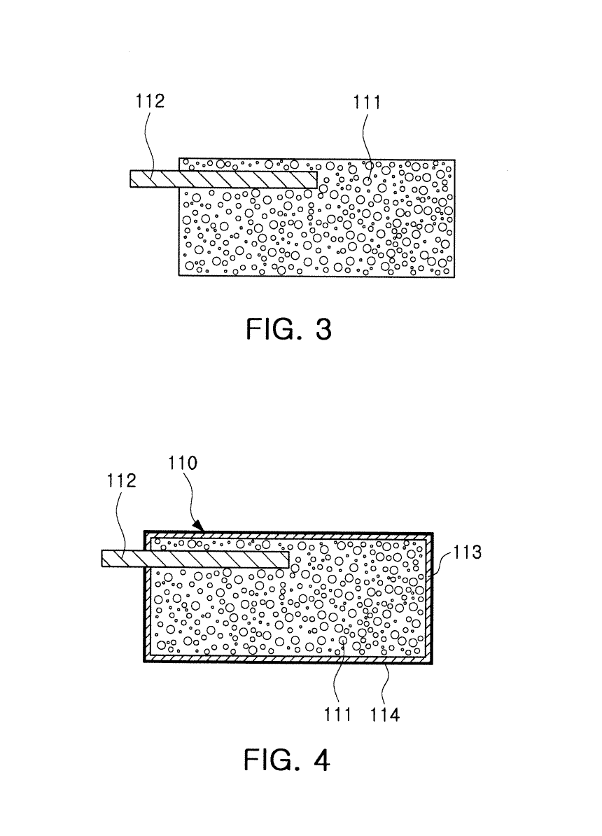

FIGS. 3 to 8 are process flow diagrams for explaining a method for manufacturing a solid electrolytic capacitor according to an exemplary embodiment of the present invention.

Referring to FIGS. 3 to 8, the condenser element 110 is molded so that the positive electrode wire 112 is disposed to be biased as shown in FIG. 3. Described in more detail, the chip body 111 is molded by mixing, for example, a tantalum powder and a binder at a predetermined ratio and agitating it, compressing the mixed powder to mold it into a rectangular parallelepiped shape, and then, sintering it under conditions of high temperature and high vibrations.

Meanwhile, the positive electrode wire 112 is inserted to be biased from the center of the chip body 111 before compressing the mixed powder and one end portion thereof is inserted and mounted to be protruded to the outside. Then, the chip body 111 is provided with the insulating layer and the negative electrode layer.

Further, the carbon layer 113 and the silver paste layer 114 may be sequentially stacked on the chip body 111 formed with the negative electrode layer in order to improve conductivity for polarity of the negative electrode layer.

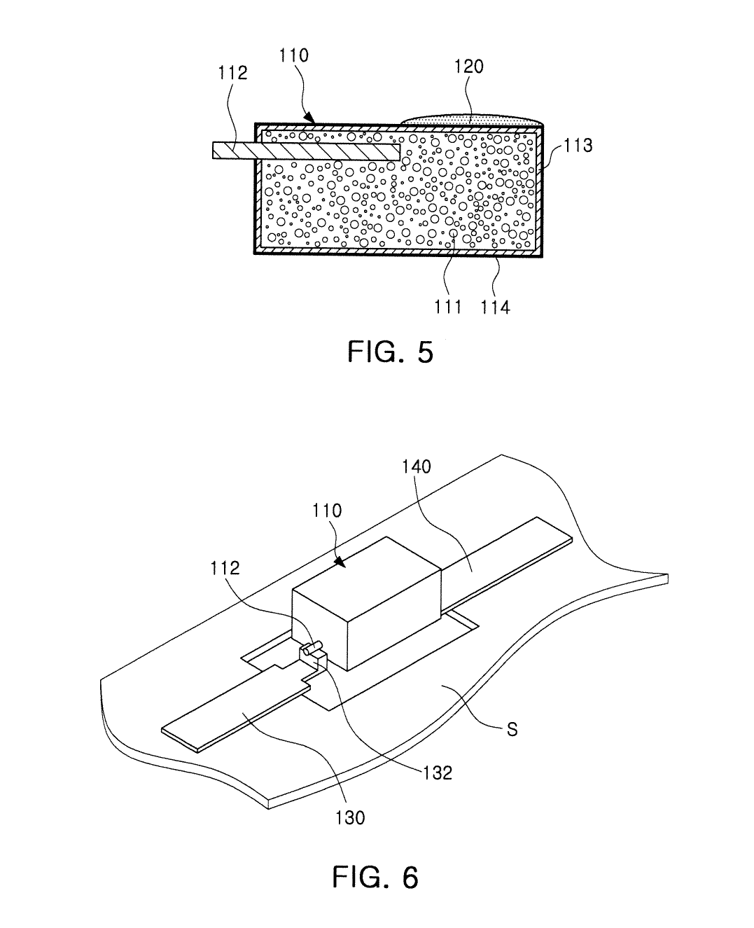

As shown in FIG. 4, after the carbon layer 113 and the silver paste layer 114 are sequentially stacked, the negative electrode extracting layer 120 maybe stacked at the end portion of a side opposite to a side in which the positive electrode wire 112 is mounted, as shown in FIG. 5. That is, the condenser element 110 may be stacked with the negative electrode extracting layer 120 so that it may be stably bonded to the negative electrode terminal 140 to be extracted.

In addition, the negative electrode extracting layer 120 may be made of a conductive paste made of gold (Au), lead (Pb), silver (Ag), nickel (Ni), copper (Cu), or the like, having viscosity and is applied to one surface of the condenser element 110 in order to have sufficient strength and hardness by the drying, hardening, and sintering processes.

Meanwhile, the negative electrode extracting layer 120 may be hardened at a temperature of between approximately 20 and 300° C.

In addition, the negative electrode extracting layer 120 may be formed on one surface of the condenser element 110 by a dispensing method, a dipping method to attach a predetermined amount of paste to one surface thereof, or a printing method to print paste on a sheet and attach it to one surface of the condenser element 110, or the like.

Meanwhile, before the condenser element 110 is molded, the pattern layer 132 bonded to the positive electrode wire 112 mounted to be biased to the one end portion of the positive electrode terminal 130 may be formed in the condenser element 110 as shown in FIG. 6. The pattern layer 132 is formed at a height at which the positive electrode wire 112 mounted in the condenser element 110 can be seated and the height of the pattern layer 132 may be changed according to the size of the condenser element 110.

Meanwhile, when the molding of the condenser element 110 is completed, the positive electrode terminal 130 and the negative electrode terminal 140 are mounted on the sheet S to be disposed apart form one another at a predetermined distance as shown in FIG. 6.

Thereafter, the condenser element 110 is mounted on the positive electrode terminal 130 and the negative electrode terminal 140 so that an end portion of the positive electrode wire 112 is seated on the pattern layer 132 of the positive electrode terminal 130. Meanwhile, the positive electrode wire 112 may be installed to be biased to the pattern layer 132 of the positive electrode terminal 130.

Therefore, the pattern layer 132 may contact the positive electrode wire 112 of the condenser element 110 by only seating the condenser element 110 on the positive electrode terminal 130 and the negative electrode terminal 140.

Thereafter, the positive electrode wire 112 and the pattern layer 132 may be fixedly bonded to each other by welding. Therefore, the positive electrode wire 112 and the pattern layer 132 may be more firmly bonded to each other.

Meanwhile, the negative electrode terminal 140 contacts the negative electrode extracting layer 120 formed at an end of a side opposite to an end in which the positive electrode wire 112 is installed.

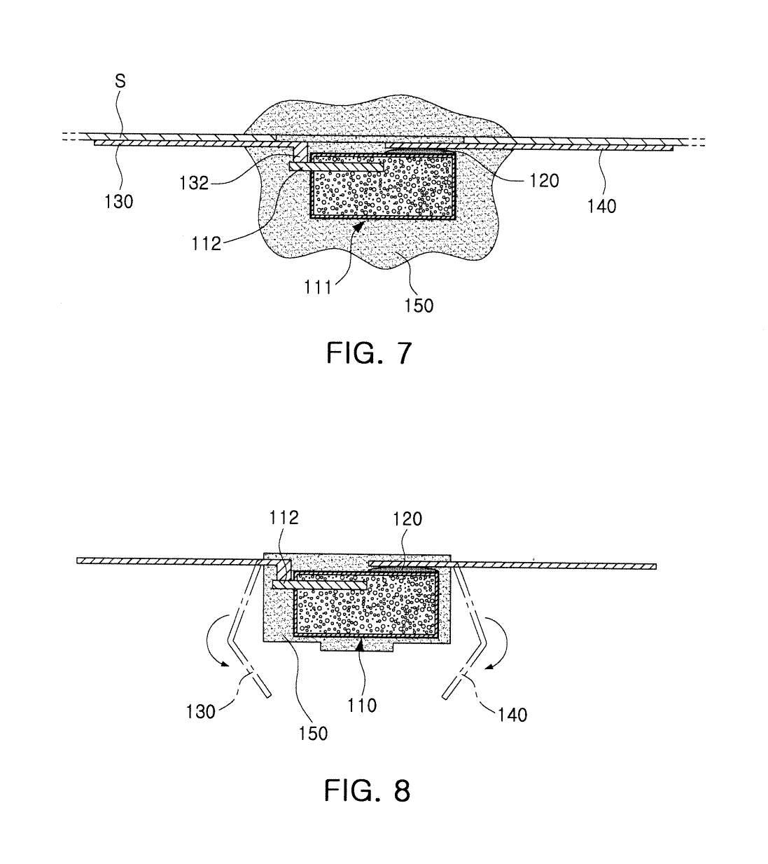

Thereafter, as shown in FIG. 7, the molding part 150 is formed to surround the condenser element 110 and the positive electrode wire 112. That is, the molding part 150 is formed to surround the condenser element 110 while protruding the positive electrode terminal 130 and the negative electrode terminal 140 to the outside. The molding part 150 is formed to surround the condenser element 110 in order to protect the condenser element 110 from the external environment.

Further, the molding part 150 may be made of an epoxy material and the molding part 150 may be made of an epoxy material including a filler having a relatively large size.

Thereafter, the molding part 150 is diced to form the appearance of the solid electrolytic capacitor 100. In this case, the molding part 150 may be cut by a dicing method using a blade or a laser.

Thereafter, as shown in FIG. 8, the positive electrode terminal 130 and the negative electrode terminal 140 are bent to be extended to the bottom surface of the molding part 150 along the outer surface of the molding part 150.

As described above, the positive negative terminal 130 and the positive electrode wire 112 are easily bonded to each other without needing to install an auxiliary combining member such as a spacer, or the like, for bonding the positive electrode wire 112 to the positive electrode terminal 130 through the positive electrode terminal 130 integrally formed with the pattern layer 132 or without bending the positive electrode terminal 130.

That is, the positive electrode wire 112 contacts the pattern layer 132 of the positive electrode terminal 130 by only seating the condenser element 110 installed to bias the positive electrode wire 112 on the positive electrode terminal 130, such that the additional process for bonding the positive electrode wire 112 to the positive electrode terminal 130 may be omitted.

Consequently, the number of manufacturing processes can be reduced and the manufacturing efficiency can be improved accordingly.

In addition, even when the solid electrolysis capacitor 100 having various sizes are manufactured, the height of the pattern layer 132 may be changed according to the biased degree of the positive electrode wire 112, such that the solid electrolytic capacitor 110 having various sizes may be more easily manufactured.

As set forth above, the present invention can easily bond the positive electrode terminal and the positive electrode wire without needing to mount the spacer for bonding the positive electrode wire to the positive electrode terminal through the positive electrode terminal including the pattern layer or bend the positive electrode terminal.

Therefore, the present invention can reduce the number of manufacturing processes, thereby making it possible to improve the manufacturing efficiency.

Further, the present invention can change the height of the pattern layer according to the biased degree of the positive electrode wire, thereby making it possible to more easily manufacture the solid electrolytic capacitor having various sizes.

While the present invention has been shown and described in connection with the exemplary embodiments, it will be apparent to those skilled in the art that modifications and variations can be made without departing from the spirit and scope of the invention as defined by the appended claims. For example, although the substrate with the ink passage has been described as the upper substrate and the lower substrate, it is exemplary and one substrate may be used or three or more substrates maybe used and various types of substrates may also be used in respects to the type of the substrate. Accordingly, the scope of the present invention will be determined by the appended claims.

What is claimed is:

1. A solid electrolytic capacitor, comprising:
a condenser element including a positive electrode wire inserted and mounted to be biased from a center of a chip body;
a positive electrode terminal including a pattern layer extendedly formed to the positive electrode wire to be bonded to the positive electrode wire; and
a negative electrode terminal electrically connected to the condenser element.

2. The solid electrolytic capacitor of claim 1, further comprising a molding part surrounding the condenser element mounted with the positive electrode wire to protrude the positive electrode terminal and the negative electrode terminal to the outside.

3. The solid electrolytic capacitor of claim 1, further comprising a negative electrode extracting layer stacked on an outer surface of the condenser element and contacting the negative electrode terminal.

4. The solid electrolytic capacitor of claim 2, wherein the positive electrode terminal and the negative electrode terminal are bent along the outer surface of the molding part to be extended to the bottom surface of the molding part.

5. A method for manufacturing a solid electrolytic capacitor, comprising:
molding a condenser element so that a positive electrode wire is disposed to be biased;
mounting the condenser element on the positive electrode terminal and the negative electrode terminal so that an end portion of the positive electrode wire is seated on the pattern layer of the positive electrode terminal; and
forming a molding part to surround the condenser element and the positive electrode wire.

6. The method for manufacturing a solid electrolytic capacitor of claim 5, further comprising, prior to the molding of the condenser element, forming a pattern layer bonded to the positive electrode wire mounted to be biased to the condenser element at one end portion of the positive electrode terminal.

7. The method for manufacturing a solid electrolytic capacitor of claim 5, wherein the positive electrode wire is mounted to be biased to the pattern layer of the positive electrode terminal.

8. The method for manufacturing a solid electrolytic capacitor of claim 5, wherein the molding part is made of an epoxy material to protect the condenser element and the positive electrode wire from an external environment.

9. The method for manufacturing a solid electrolytic capacitor of claim 5, further comprising, after the forming of the molding part, bending the positive electrode terminal and the negative electrode terminal to be extended to the bottom surface of the molding part along the outer surface of the molding part.
